(19) United States
(12) Patent Application Publication
(10) Pub. No.: US 2010/0154412 A1
(43) Pub. Date: Jun. 24, 2010

(54) APPARATUS AND METHOD FOR PROVIDING THERMAL MANAGEMENT OF A SYSTEM

(75) Inventors: MORGAN ANDREAE, COLUMBUS, IN (US); VIVEK SUJAN, COLUMBUS, IN (US); KIRTAN BHANDARY, COLUMBUS, IN (US); TIM FRAZIER, COLUMBUS, IN (US); ADRIAN DALE, COLUMBUS, IN (US); JEFFREY MATTHEWS, COLUMBUS, IN (US)

Correspondence Address: KRIEG DEVAULT LLP, ONE INDIANA SQUARE, SUITE 2800, INDIANAPOLIS, IN, 46204-2079, US

(73) Assignee: CUMMINS INC., INDIANAPOLIS, IN (US)

(21) Appl. No.: 12/343,462

(22) Filed: Dec. 23, 2008

(51) Int. Cl. F02D 23/00; F02M 25/07

(52) U.S. Cl. 60/600; 60/605.2; 123/568.12

(57) ABSTRACT

An embodiment is an apparatus for providing thermal management of a diesel aftertreatment device. The apparatus includes an intake throttle, at least one exhaust gas recirculation (EGR) valve coupled to the intake throttle, a turbine bypass valve coupled to the at least one EGR valve and a control mechanism coupled to the intake throttle, the at least one EGR valve and the turbine bypass valve for selectively actuating at least one of the valves based on an engine operation profile.

### FIELD OF THE INVENTION

The present invention relates generally to diesel engines and more specifically to an apparatus and method for providing thermal management.

### BACKGROUND OF THE INVENTION

Current emission control regulations necessitate the use of catalysts in the exhaust systems of automotive vehicles in order to convert carbon monoxide (CO), hydrocarbons (HC), and nitrogen oxides (NOx) produced during engine operation into harmless exhaust gasses. Vehicles equipped with diesel or lean gasoline engines offer the benefits of increased fuel economy. Such vehicles have to be equipped with lean exhaust aftertreatment devices such as, for example, Active Lean NOx Catalysts (ALNC), which are capable of continuously reducing NOx emissions, even in an oxygen rich environment. In order to maximize NOx reduction in the ALNC, a hydrocarbon-based reductant, such as fuel (HC), has to be added to the exhaust gas entering the device.

Many diesel aftertreatment devices periodically require high temperatures for optimal operation. Exhaust gas temperature is a function of engine operating condition. However, a particular engine operating condition may or may not provide the required temperatures. Fuel injection strategy can be modified to raise exhaust temperatures, but at low engine loads and low speeds this approach may not be sufficient to meet thermal requirements and new strategies are needed.

Another method for reducing the amount of undesired pollutants is to employ an exhaust gas recirculation (EGR) system in the exhaust stream of an internal combustion engine to re-route exhaust gases back through the engine for more complete combustion to take place, thus lowering the amount of pollutants ultimately allowed to enter the atmosphere.

Particulate matter (PM) can also be used in conjunction with EGR systems. PM filters work well but must be “cleaned out”, i.e., regenerated from time to time, as the particulate matter accumulates. A common method for regenerating PM filters is to increase the temperature within the filter, thus causing the accumulated matter to combust and bum. The temperature increase may be done actively by the use of heating elements installed in the filter, or may be done by increasing the temperature of the exhaust gases passing through the filter.

Another system is a urea-based SCR (Selective Catalytic Reduction) system. The Urea-SCR System is capable of removing the majority of nitrogen oxides (NOx) and unburned hydrocarbons as well as a significant fraction of the particles in the diesel exhaust, components which all affect the human health. NOx is a precursor for smog, which is undesirable because of its impact on the human respiratory tract. The obnoxious smell of diesel exhaust is mainly due to its content of unburned hydrocarbons. Removal hereof improves the working environment around the diesel vehicle significantly. Measurements show that the SCR catalyst removes especially the small (ultra-fine) particles which are believed to present the biggest health hazard.

### SUMMARY OF THE INVENTION

In varying embodiments, a means of maintaining high exhaust temperatures periodically desired by diesel aftertreatment devices is disclosed. At high engine loads and engine speeds, the exhaust temperatures usually meet requirements for regeneration of aftertreatment devices. At low engine loads and low engine speeds where exhaust temperatures are usually not very high, new strategies are needed. Accordingly, the present inventive concepts incorporate a number of features that allow for the implementation of a variety of strategies to raise exhaust temperatures to the desired levels.

A first embodiment is an apparatus for providing thermal management of a system. The apparatus includes an intake throttle, at least one exhaust gas recirculation (EGR) valve coupled to the intake throttle, a turbine bypass valve coupled to the at least one EGR valve and a control mechanism coupled to the intake throttle, the at least one EGR valve and the turbine bypass valve for selectively actuating at least one of the valves based on an engine operation profile.

A second embodiment is a method of managing thermal conditions in a system. The method includes providing an intake valve, providing at least one exhaust gas recirculation (EGR) valve, providing a turbine bypass valve coupled to the at least one EGR valve and selectively actuating at least one of the valves based on an engine operation profile.

A third embodiment is an engine. The engine includes an intake throttle, at least one EGR valve coupled to the intake throttle, a turbine bypass valve coupled to the at least one EGR valve and a control mechanism coupled to the intake throttle, the at least one EGR valve and the turbine bypass valve for selectively actuating at least one of the valves based on an engine operation profile.

### BRIEF DESCRIPTION OF DRAWINGS

FIG. 1 shows an apparatus in accordance with an embodiment.

FIG. 2 is a flowchart of a method in accordance with an embodiment.

FIG. 3 shows an example of an engine operating profile in accordance with an embodiment.

FIG. 4 shows a conceptual overview of the turbine configuration in accordance with an embodiment.

FIG. 5 shows the first embodiment of the turbine bypass valve.

FIG. 6 illustrates a conceptual view of a turbine configuration in accordance with a second embodiment.

FIG. 7 shows the second embodiment of the turbine bypass valve.

FIG. 8 shows the primary conduit and the bypass conduit in conjunctive cooperation with the first hole and the second hole of the turbine bypass valve.

FIG. 9 shows the turbine bypass valve in between the exhaust manifold and the HP turbine in accordance with an embodiment.

FIG. 10 shows the turbine bypass valve directly adjacent the LP turbine in accordance with an embodiment.

FIG. 11 illustrates a conceptual view of a turbine configuration in accordance with an third embodiment.

FIG. 12 shows the two valves in between the exhaust manifold and the HP turbine in accordance with an embodiment.

FIG. 13 shows the two valves directly adjacent the LP turbine in accordance with an embodiment.

### DETAILED DESCRIPTION

The present disclosure relates to an apparatus and method of providing thermal management of a system. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In varying embodiments, a means of maintaining high exhaust temperatures periodically desired by diesel aftertreatment devices is disclosed. At high engine loads and engine speeds exhaust temperatures usually meet requirements for regeneration of aftertreatment devices. At low engine loads and low engine speeds where exhaust temperatures are usually not very high, new strategies are needed. Accordingly, the present inventive concepts incorporate a number of features that allow for the implementation of a variety of strategies to raise exhaust temperatures to the desired levels.

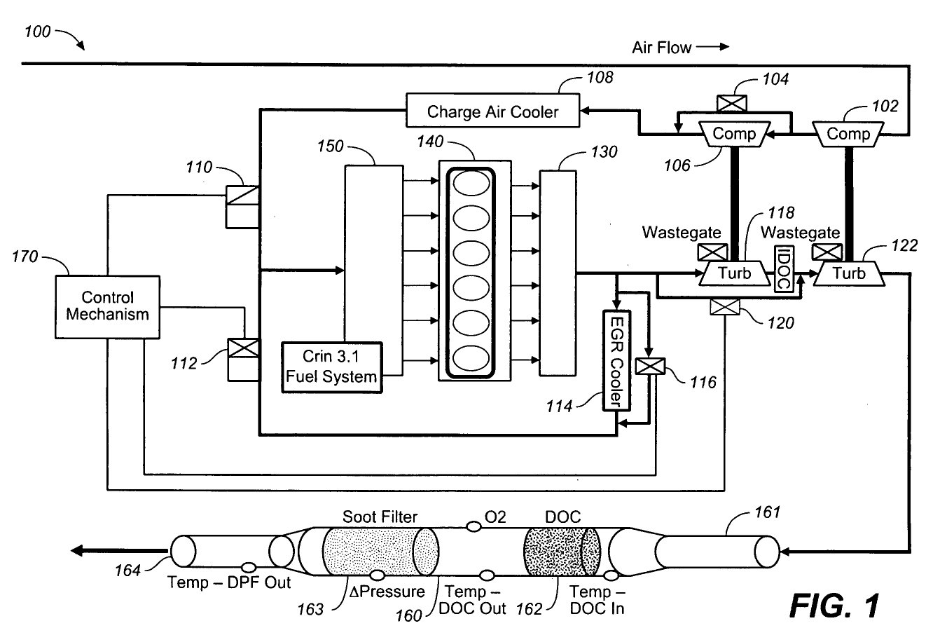

FIG. 1 shows an apparatus 100 in accordance with an embodiment. The apparatus includes compressors 102, 106, a compressor bypass valve 104, a charge air cooler 108, an intake throttle 110, an exhaust gas recirculation (EGR) valve 112 coupled to the intake throttle 110, an EGR cooler 114, an EGR cooler bypass valve 116, a high pressure (HP) turbocharger 118, a low-pressure (LP) turbocharger 122 and a turbine bypass valve 120. Also shown is an exhaust manifold 130, a crankcase 140, an intake manifold 150 and an exhaust configuration 160 that includes an exhaust intake 161, a catalyzed soot filter 163, a diesel oxidation catalyst (DOC) 163 and an exhaust outlet 164. Finally, a control mechanism 170 for controlling the selective actuation of the valves is shown. In an embodiment, the apparatus is an engine or the like and the control mechanism 170 includes hardware and/or software control components.

The key hardware features used in the thermal management strategy are the intake throttle 110, the compressor bypass valve 104, the EGR valve 112, the EGR cooler bypass valve 116 and the turbine bypass valve 120. These features impact engine operation in two broad ways. First, they control the composition and quantity of gases entering the cylinders. Higher ratios of fuel mass to fresh air plus EGR mass lead to higher combustion temperatures and therefore higher exhaust temperatures. Second, these features can impact engine efficiency. Less efficient engine operation results in more fuel consumption for a given brake power, and therefore higher exhaust gas temperatures for that brake power.

The fuel system is also a useful piece of hardware in the thermal management system. By adjusting the fuel injection strategy, not only can the exhaust temperature be increased, but unburned hydrocarbons can be generated. These unburned hydro-carbons (if temperatures are high enough) will oxidize at the DOC, further raising the exhaust gas temperatures.

Additionally, in FIG. 1, a block labeled IDOC is shown between the HP and LP turbines. IDOC (or IDOC) stands for interstage DOC (Diesel Oxidation Catalyst). This purpose of this DOC is to oxidize hydrocarbons during normal operation to minimize hydrocarbons emissions (exhaust temperatures at low loads can be low enough with high EGR rates, that the downstream DOC is not particularly effective). During thermal management, significant hydrocarbons are generated to raise the temperature of the exhaust at the downstream DOC. The HP turbine is mostly bypassed during thermal management, but some flow is required to maintain minimum HP turbine speed (maintain thrust margin in HP turbo). The unburned hydrocarbons in this small amount of flow through the HP turbine will oxidize in the IDOC during thermal management.

Flow of fresh air into the engine can be limited in a number of ways. The intake throttle 110 can be closed. The compressor bypass valve 104 can be opened to reduce the boost and therefore fresh air flow. The turbine bypass valve 120 can be actuated to allow flow to bypass the HP turbine 118, also reducing boost. The HP turbine 118 can be bypassed partially or completely. Furthermore, an exhaust braking feature of the turbine bypass valve 120 can be enabled, resulting in higher back pressure and lower flow through the engine.

Exhaust braking involves closing off the exhaust path from the engine, causing the exhaust gases to be compressed in the exhaust manifold and in the cylinder. Since the exhaust is being compressed, and there is no fuel being applied, the engine works backwards, whereby the amount of negative torque generated is usually directly proportional to the back pressure of the engine.

Additionally, the EGR valve 112 can also be used to reduce fresh air flow. Opening the EGR valve 112 displaces fresh air with EGR. By using both the EGR valve 112 and the intake throttle 110, both the charge flow and EGR fraction can be controlled. Although lowering the fresh air flow generally helps increase combustion temperatures, higher EGR fractions lower the temperature of combustion. However, the use of some EGR may be necessary during thermal management to reduce emissions of NOx. The impact on exhaust temperature can be minimized by using hot EGR instead of cooled EGR. The EGR cooler bypass valve 116 allows for the flow of EGR to bypass the EGR cooler 114. Bypassing the cooler 114 avoids any problems with fouling the cooler 114 with unburned hydrocarbons if in-cylinder dosing is used for thermal management. Consequently, the selective actuation of EGR valve 112, EGR cooler bypass valve 116, and intake throttle 110 can achieve a wide range of charge compositions and flows.

All of these features can also be used to reduce the efficiency of the engine. Closing the throttle 110 increases pumping work. Boost can be reduced by either opening the compressor bypass 104 or by actuating the turbine bypass valve 120 to bypass the HP turbine 118. Lower boost will lead to less charge mass, lower peak cylinder pressures and temperatures, and less efficient combustion. Furthermore, actuating the three way valve to act as an exhaust brake reduces efficiency by increasing the pumping work of the engine.

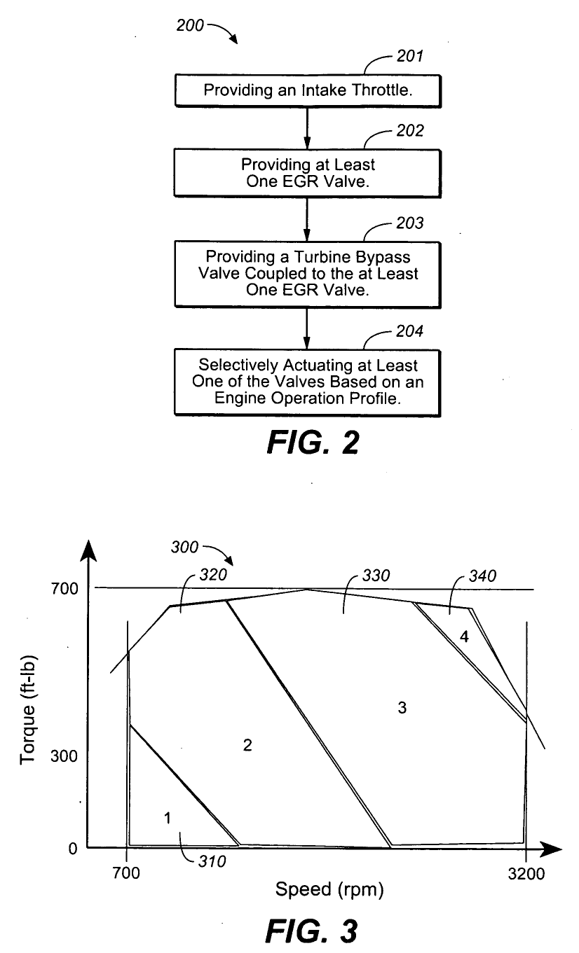

In this regard, another embodiment of is a method of managing thermal conditions in a system. Accordingly, FIG. 2 shows a flowchart 200 of a method of managing thermal conditions in a system in accordance with an embodiment. A first step 201 involves providing an intake throttle. A second step 202 involves providing at least one EGR valve. A third step 203 involves providing a turbine bypass valve coupled to the at least one EGR valve. A final step 204 involves selectively actuating at least one of the valves based on an engine operation profile.

As mentioned above, the selective actuation of the intake throttle 110, the compressor bypass valve 104, the EGR valve 112, the EGR cooler bypass valve 116 and the turbine bypass valve 120 are determined based on a four region engine operation profile. FIG. 3 shows an engine operation profile 300 in accordance with an embodiment. In this particular embodiment, the engine operation profile 300 is an engine torque vs. engine speed profile but one of ordinary skill will readily recognize that a variety of different profiles could be employed while remaining within the spirit and scope of the inventive concepts.

As can be seen in FIG. 3, the engine operation profile 300 includes a first region 310, a second region 320, a third region 330 and a fourth region 340. The first region 310 of the engine operation profile 300 includes an engine speed of substantially 800-1000 rpm and a torque of substantially 0-100 ft.-lb, the second region 320 of the engine operation profile 300 includes an engine speed of substantially 1000-1800 rpm and a torque of substantially 100-300 ft.-lb and the third region 330 includes an engine speed of over 1800 rpm and a torque of over 300 ft.-lb.

The fourth region 340 encompasses area near the rated power of the engine where no modification of engine operation strategy is needed. This region can be defined by engine power output greater than 90% of rated power. In region 1, all available levers are needed. In region 2, intake throttle is not needed. In region 3, only changes in fuel injection strategy are needed. In region 4—no modification of strategy is employed.

Although FIG. 3, shows an engine operation profile 300 in accordance with an embodiment, one of ordinary skill in the art will readily recognize this profile 300 is exemplary and a variety of profiles could be employed in conjunction with a variety of engines while remaining within the spirit and scope of the present inventive concepts.

During operation, exhaust temperatures are usually not very high at low engine loads and low engine speeds. Here, the selective actuation of the intake throttle 110, the compressor bypass valve 104, the EGR valve 112, the EGR cooler bypass valve 116 and the turbine bypass valve 120 is employed to increase the operational temperatures based on the engine operation profile 300. In an embodiment, when the engine operation conditions are in the first region 310, the intake throttle valve 110 is actuated (i.e. closed) to reduce air flow, EGR flow through the EGR valve 112 is regulated, the EGR cooler 114 is bypassed and the turbine bypass valve 120 is regulated to maintain a predetermined thrust margin and minimize flow through the HP turbine 118. Additionally, the fuel injection strategy should be altered (e.g. multiple late injections to maintain combustion temperatures).

Alternatively, when the engine operation conditions are in the first region 310, a 3-way valve can be employed as the turbine bypass valve 120 to allow for exhaust braking. 3-way valves are commonly made such that flow coming in at one port can be directed to either the second port in one position or the third port in another position or in an intermediate position so all flow is stopped. Employing a 3-way valve as the turbine bypass valve 120 to allow for exhaust braking, adds back pressure to the engine, locks out flow through the HP turbine 118 and restricts flow to the LP turbine 122. Additionally, pumping work is increased thereby raising the exhaust temperature. In this embodiment, intake throttle valve 100 is left open, the EGR cooler 114 is bypassed and EGR flow through the EGR valve 112 is regulated. Again, the fuel injection strategy here can be altered accordingly.

When the engine operation conditions are in the second region 320, the intake throttle valve 110 is not actuated, EGR flow through the EGR valve 112 is regulated, the EGR cooler 114 is bypassed and the turbine bypass valve 120 is regulated to maintain a predetermined thrust margin and minimize flow through the HP turbine 118. Fuel injection is altered accordingly.

With regard to the third and fourth regions 330, 340, the third region 340 is mostly passive and the requisite exhaust temperatures can be reached without much intervention. Here, late fuel injections can be employed in conjunction with bypassing the EGR cooler 116 and regulating the EGR valve 112. In the fourth region 340, normal steady state operation is achieved and no intervention is needed.

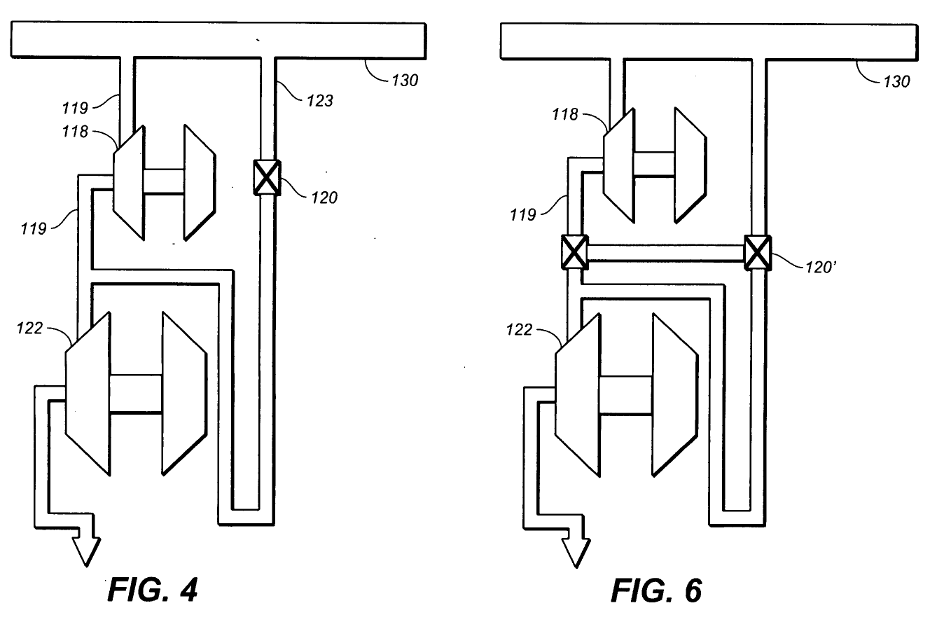

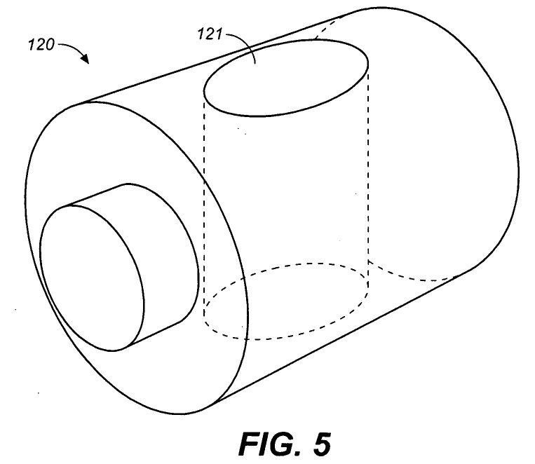

In order to accommodate the above-described actuation sequencing, varying embodiments of the turbine bypass valve 120 are contemplated. FIG. 4 shows a conceptual overview of the turbine configuration in accordance with an embodiment. FIG. 4 shows the exhaust manifold 130 coupled to the HP turbine 118 via a primary conduit 119. Also shown is the LP turbine 122 and the turbine bypass valve 120 whereby turbine bypass valve 120 is coupled to the exhaust manifold 130 via a bypass conduit 123. In this embodiment, the turbine bypass valve 120 is a single actuator, single hole bypass valve. FIG. 5 shows the first embodiment of the turbine bypass valve 120. Here, the valve 120 includes a single hole 121. Accordingly, the hole 121 engages the bypass conduit 123 incrementally when an HP turbine 118 bypass is desired.

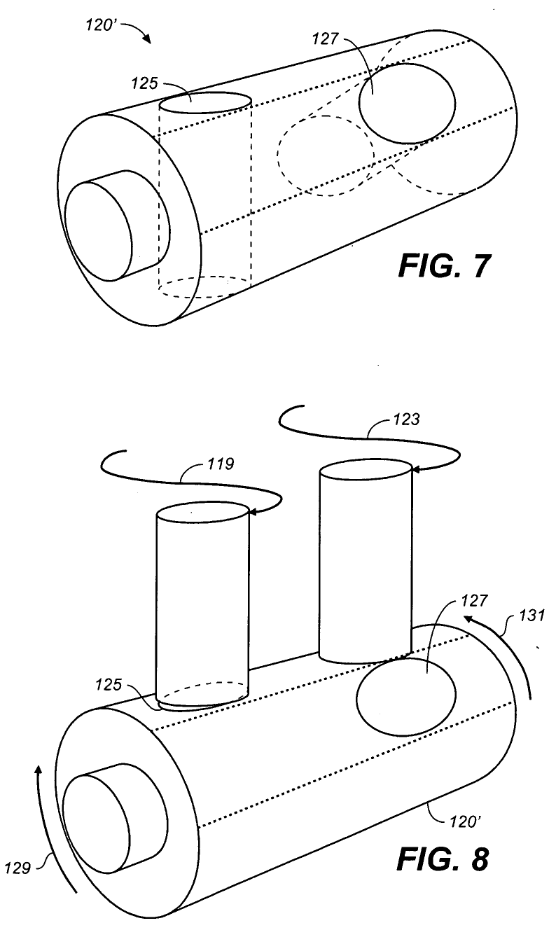

FIG. 6 illustrates a conceptual view of a turbine configuration in accordance with an alternate embodiment. FIG. 6 shows the exhaust manifold 130 coupled to the HP turbine 118 via a primary conduit 119. Also shown is the LP turbine 122 and the turbine bypass valve 120′ whereby turbine bypass valve 120′ is coupled to the exhaust manifold 130 via a bypass conduit 123. In this embodiment, the turbine bypass valve 120′ is a single actuator, double hole bypass valve. FIG. 7 shows the second embodiment of the turbine bypass valve 120′. Here, the valve 120′ includes two holes 125 and 127. The holes 125 and 127 are offset (position and angle) and sized such that when an HP turbine 118 bypass is desired, the bypass conduit 123 is engaged while simultaneously disengaged. This is more clearly shown in FIG. 8.

FIG. 8 shows the primary conduit 119 and the bypass conduit 123 in conjunctive cooperation with the first hole 125 and the second hole 127 respectively. Accordingly, rotation in the clockwise direction 129 disengages both the primary conduit 119 and the bypass conduit 123 thereby providing for exhaust throttling. Consequently, rotation in the counterclockwise direction 131 engages both the primary conduit 119 and the bypass conduit 123.

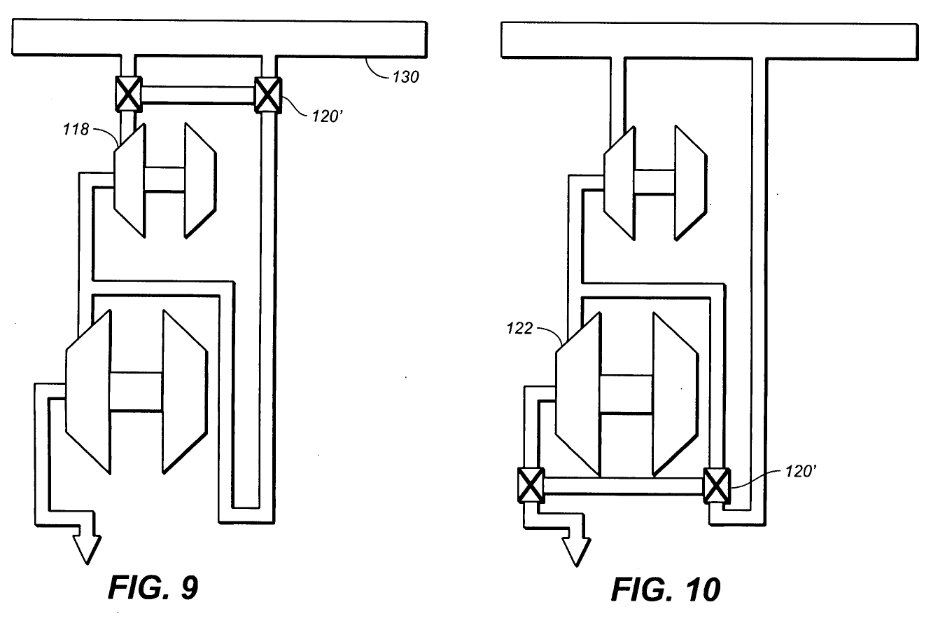

Although, FIG. 6 shows the turbine bypass valve 120′ in between the HP turbine 118 and the LP turbine 122, other configurations could be employed. For example FIG. 9 shows the turbine bypass valve 120′ in between the exhaust manifold 130 and the HP turbine 118. Furthermore, FIG. 10 shows the turbine bypass valve 120′ directly adjacent the LP turbine 122.

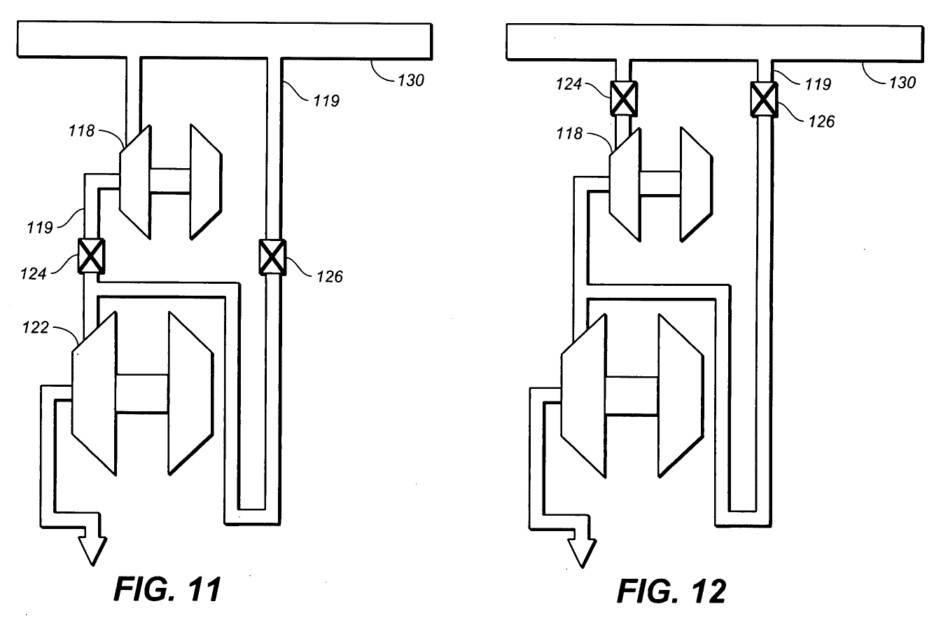

A challenge with the single actuator, double hole turbine bypass valve is the physical size. However, FIG. 11 illustrates a conceptual view of a turbine configuration in accordance with an third embodiment. FIG. 11 shows the exhaust manifold 130 coupled to the HP turbine 118 via a primary conduit 119 and the LP turbine 122. However, two valves are employed here: a first valve 124 in conjunction with the HP turbine 118 and the primary conduit 119 and a second actuator 126 in conjunction with bypass conduit whereby the first valve 124 is binary. Accordingly, for exhaust throttling the second valve 126 is closed ‘slowly’ and the first valve 124 is opened. Progressive closing of the first valve 124 increases restriction if desired.

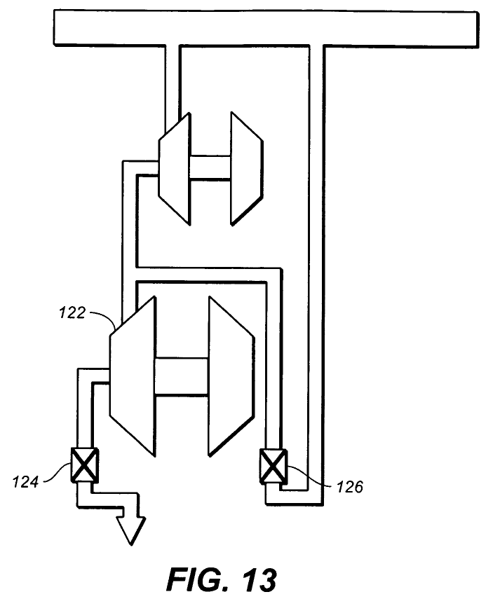

Again, although FIG. 11 shows the two valves in between the HP turbine 118 and the LP turbine 122, other configurations could be employed. For example, FIG. 12 shows the two valves 124, 126 in between the exhaust manifold 130 and the HP turbine 118 and FIG. 13 shows the two valves 124, 126 directly adjacent the LP turbine 122.

In varying embodiments, a means of maintaining high exhaust temperatures periodically desired by diesel aftertreatment devices is disclosed. At high engine loads and engine speeds exhaust temperatures usually meet requirements for regeneration of aftertreatment devices. At low engine loads and low engine speeds where exhaust temperatures are usually not very high, new strategies are needed. Accordingly, the above-described inventive concepts incorporate a number of features that allow for the implementation of a variety of strategies to raise exhaust temperatures to the desired levels.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although these inventive concepts have been described in terms of certain embodiments, other embodiments that are apparent to those of ordinary skill in the art are also within the scope of this invention, as defined in the claims that follow.

What is claimed is:

1. An apparatus for providing thermal management of a diesel aftertreatment device comprising:
an intake throttle;
at least one exhaust gas recirculation (EGR) valve coupled to the intake throttle;
a turbine bypass valve coupled to the at least one EGR valve; and
a control mechanism coupled to the intake throttle, the at least one EGR valve and the turbine bypass valve for selectively actuating at least one of the valves based on an engine operation profile.

2. The apparatus of claim 1 wherein the turbine bypass valve further comprises a three-way bypass valve.

3. The apparatus of claim 2 wherein the turbine bypass valve is coupled to a low pressure turbine and a high pressure turbine.

4. The apparatus of claim 1 wherein the turbine bypass valve comprises a single actuator, single hole turbine bypass valve.

5. The apparatus of claim 1 wherein the turbine bypass valve comprises a single actuator, double hole turbine bypass valve.

6. The apparatus of claim 1 wherein the turbine bypass valve comprises a double actuator, double hole turbine bypass valve.

7. The apparatus of claim 6 wherein one of the two actuators is binary.

8. The apparatus of claim 1 wherein the engine operation profile is an engine speed vs. engine torque profile and comprises at least three predetermined regions.

9. The apparatus of claim 8 wherein a first region of the engine operation profile comprises an engine speed of substantially 800-1000 rpm and a torque of substantially 0-100 ft.-lb.

10. The apparatus of claim 9 wherein a second region of the engine operation profile comprises an engine speed of substantially 1000-1800 rpm and a torque of substantially 100-300 ft.-lb.

11. A method of managing thermal conditions in a diesel aftertreatment device comprising:
providing an intake valve;
providing at least one EGR valve;
providing a turbine bypass valve coupled to the at least one EGR valve; and
selectively actuating at least one of the valves based on an engine operation profile.

12. The method of claim 11 wherein the turbine bypass valve further comprises a three-way bypass valve.

13. The method of claim 12 wherein the turbine bypass valve further comprises a single actuator, single hole turbine bypass valve.

14. The method of claim 12 wherein the turbine bypass valve comprises a single actuator, double hole turbine bypass valve.

15. The method of claim 12 wherein the turbine bypass valve comprises a double actuator, double hole turbine bypass valve.

16. The method of claim 15 wherein one of the two actuators is binary.

17. The method of claim 11 wherein the engine operation profile is an engine speed vs. engine torque profile and comprises at least three predetermined regions.

18. The method of claim 17 wherein a first region of the engine operation profile comprises an engine speed of substantially 800-1000 rpm and a torque of substantially 0-100 ft.-lb.

19. The method of claim 18 wherein a second region of the engine operation profile comprises an engine speed of substantially 1000-1800 rpm and a torque of substantially 100-300 ft.-lb.

20. The method of claim 18 wherein the at least one EGR valve further comprises an EGR cooler bypass valve and the step of selectively actuating at least one of the valves based on an engine operation profile further comprises:
actuating the intake throttle;
opening the EGR cooler bypass valve; and
regulating the turbine bypass valve is regulated to maintain a predetermined thrust margin and minimize flow through a turbine.

21. The method of claim 18 wherein the turbine bypass valve further comprises a three-way bypass valve and the at least one EGR valve further comprises an EGR cooler bypass valve and the step of selectively actuating at least one of the valves based on an engine operation profile further comprises:
opening the intake throttle;
opening the EGR cooler bypass valve; and
providing exhaust braking with the three-way bypass valve.

22. An engine comprising:
an intake throttle;
at least one EGR valve coupled to the intake throttle;
a turbine bypass valve coupled to the at least one EGR valve; and
a control mechanism coupled to the intake throttle, the at least one EGR valve and the turbine bypass valve for selectively actuating at least one of the valves based on an engine operation profile.

23. The engine of claim 22 wherein the turbine bypass valve further comprises a three-way bypass valve.

24. The engine of claim 22 wherein the at least one EGR valve further comprises an EGR cooler bypass valve.

25. The engine of claim 22 wherein the engine operation profile is an engine speed vs. engine torque profile and comprises at least three predetermined regions.

26. The engine of claim 25 wherein a first region of the engine operation profile comprises an engine speed of substantially 800-1000 rpm and a torque of substantially 0-100 ft.-lb.

27. The engine of claim 26 wherein a second region of the engine operation profile comprises an engine speed of substantially 1000-1800 rpm and a torque of substantially 100-300 ft.-lb.
